(19) United States
(12) Patent Application Publication
(10) Pub. No.: US 2019/0387925 A1
(43) Pub. Date: Dec. 26, 2019

(54) MODULE AND PREFABRICATED BODY USING SAME FOR BRAZIER AND ROASTER

(71) Applicant: DONGWON HI-TECH CO., LTD., Incheon (KR)

(72) Inventors: SUN HO KWON, Incheon (KR); YONG JAE CHOE, Incheon (KR); SEUNG BEOM JO, Incheon (KR); NAM JUN CHOE, Incheon (KR)

(21) Appl. No.: 16/447,051

(22) Filed: Jun. 20, 2019

(30) Foreign Application Priority Data
Jun. 22, 2018 (KR) 10-2018-0072087

(51) Int. Cl. A47J 37/07

(52) U.S. Cl. CPC A47J 37/0786; A47J 37/0704

(57) ABSTRACT

Provided is the prefabricated body using a module for a roaster according to an embodiment of the present invention, the prefabricated body including: a module including a module body provided with a fastening hole on one end side surface thereof, a first coupling groove provided in a longitudinal direction at a side of the module body, and a second coupling groove provided in the longitudinal direction at an opposite side of the module body at an arbitrary angle with the first coupling groove; a polygonal body with both ends open configured by module plates detachably coupled correspondingly with the first and second coupling grooves; a door openably installed at an opening at a side of the polygonal body; and a side plate installed at one opening at an opposite side of the polygonal body so as to face the door by a fastening member coupled with the fastening hole.

### CROSS-REFERENCE TO RELATED APPLICATIONS

The present application claims priority to Korean Patent Application No. 10-2018-0072087, filed Jun. 22, 2018, the entire contents of which is incorporated herein for all purposes by this reference.

### FIELD

The present invention relates to a body for a roaster and, more particularly, to a module and a prefabricated body using the same for a brazier and roaster to roast various kinds of food such as meat and the like by charcoal or an electrothermal heater inside the body or to use outdoors as a substitute for a brazier.

### BACKGROUND

Unless otherwise indicated herein, contents set forth in this section are not conventional art to the claims of this application and are not to be construed as conventional art because of inclusion thereof in this section.

Although not shown in drawings, a stove with a roaster disclosed in Korean Utility Model Registration No. 20-0466279 of the conventional art is provided with a main body having a castor at a bottom portion thereof to easily moving thereof. In addition, a roaster portion capable of roasting meat is integrally provided at a top portion of the main body so that it is not necessary to separately provide a roasting plate, and a shelf is provided on each side of the main body so as to be foldable.

Therefore, when charcoal placed on a pedestal is lit, it is possible to roast various kinds of meat put on a grill of the roaster portion by thermal power. In addition, when the grill is covered with a lid, various kinds of food can be cooked by being steamed. Further, when temperature drops at indoors and outdoors, the main body can be used as a brazier.

The conventional stove with a roaster as described above is manufactured only to a degree that the grill is additionally installed at an opening of the stove, and is not manufactured to be able to be separated and assembled. Accordingly, the conventional stove with a roaster has a problem of being unable to be easily carried and stored due to overall weight and an external size thereof.

In addition, because the main body and the roaster portion are integrally provided, the roaster portion or the grill is not easy to be cleaned frequently after roasting or cooking food such as the meat and the like, thereby inducing a problem of deteriorating hygiene.

The conventional stove with a roaster is disclosed in Korean Utility Model Registration No. 20-0466279.

The foregoing is intended merely to aid in the understanding of the background of the present invention, and is not intended to mean that the present invention falls within the purview of the related art that is already known to those skilled in the art.

### SUMMARY

Accordingly, the present invention has been made keeping in mind the above problems occurring in the related art, and an embodiment of the present invention relates to a module and a prefabricated body using the same for a brazier and roaster, in which the polygonal body (referring to a main body in which charcoal is accommodated and an upper body in which a grill is housed) for the roaster is detachably assembled, thereby being allowed to be frequently separated and easily cleaned.

The embodiment of the present disclosure relates to the module and the prefabricated body using the same for the brazier and roaster, in which the polygonal body for the roaster is assembled to be replaceable by the module having compatibility, thereby enabling volume and an external size thereof to be adjusted.

The embodiment of the present invention relates to the module and the prefabricated body using the same for the brazier and roaster, in which the polygonal body for the roaster is provided with a vent pipe for discharging smoke and exhaust gas, thereby being usable outdoors for enabling various kinds of food such as meat and the like to be roasted by charcoal and the like or being used as the substitute for a brazier for heating.

In order to achieve an above objective and other objectives of the present specification, according to the embodiment of the present invention, there may be provided the module including a module body provided with a fastening hole on an end side surface thereof, a first coupling groove provided in a longitudinal direction at a side of the module body, and a second coupling groove provided in the longitudinal direction at an opposite side of the module body at an arbitrary angle with the first coupling groove.

According to the embodiment of the present invention, there is provided the prefabricated body using the module for a brazier and roaster, the prefabricated body including: the module including the module body provided with a fastening hole on an end side surface thereof, a first coupling groove provided in a longitudinal direction at a side of the module body, and a second coupling groove provided in the longitudinal direction at an opposite side of the module body at an arbitrary angle with the first coupling groove; a polygonal body with both ends open and configured by module plates detachably coupled correspondingly with the first and second coupling grooves; a door openably installed at an opening at a side of the polygonal body; and a side plate installed at an opening at an opposite side of the polygonal body so as to face the door by a fastening member coupled with the fastening hole.

Accordingly, the present invention having an above-described configuration has following advantages.

First, because the polygonal body for the roaster is detachably assembled, the polygonal body can be frequently separated and easily cleaned, whereby various foods can be cooked in a hygenic state and be tasted.

Second, because the polygonal body for the roaster is assembled to be replaceable by the module having compatibility, thereby enabling volume and an external size thereof to be adjusted, the polygonal body for the roaster can be used as a portable device for camping or a device for commercial use (referring to business use).

Third, the polygonal body for the roaster is provided with the vent pipe for discharging smoke and exhaust gas, thereby being useable outdoors for enabling various kinds of food such as meat and the like to be roasted by charcoal and the like or being used as a substitute for a brazier for heating, thus the polygonal body for the roaster becomes to have practicality and competitiveness in a field of the same type industry.

### DRAWINGS

The above and other objectives, features and other advantages of the present invention will be more clearly understood from the following detailed description when taken in conjunction with the accompanying drawings, in which:

FIGS. 1A, 1B, 1C, and 1D are perspective views of corresponding modules in prefabricated bodies using the same for a brazier and roaster according to a preferred embodiment of the present invention;

FIGS. 2A, 2B, 2C, and 2D are perspective views of the prefabricated bodies using the modules for the brazier and roaster shown in FIGS. 1A, 1B, 1C, and 1D, respectively;

FIG. 3 is a perspective view of the brazier and roaster using the polygonal body assembled by the module shown in FIG. 1A;

FIG. 4 is an exploded perspective view of the brazier and roaster shown in FIG. 3;

FIG. 5 is a sectional view showing a use state of the brazier and roaster shown in FIG. 3; and

FIGS. 6A, 6B, 6C, and 6D are sectional views of the modules shown in FIGS. 1A, 1B, 1C, and 1D, respectively.

### DETAILED DESCRIPTION

Hereinbelow, a module and a prefabricated body using the same for a brazier and roaster according to an exemplary embodiment of the present invention will be described in detail with reference to the accompanying drawings. Throughout the drawings, the same reference numerals will refer to the same or like parts.

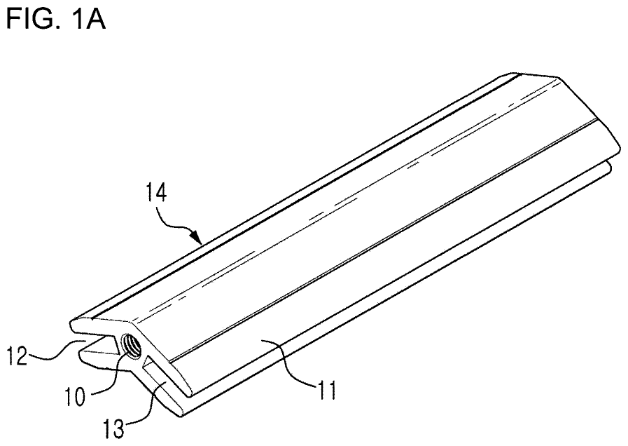

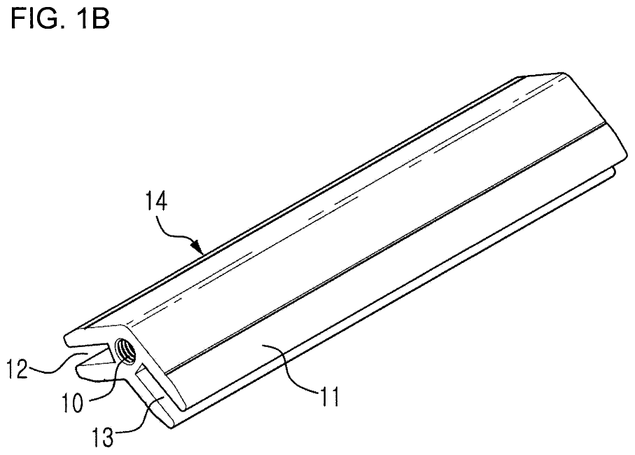

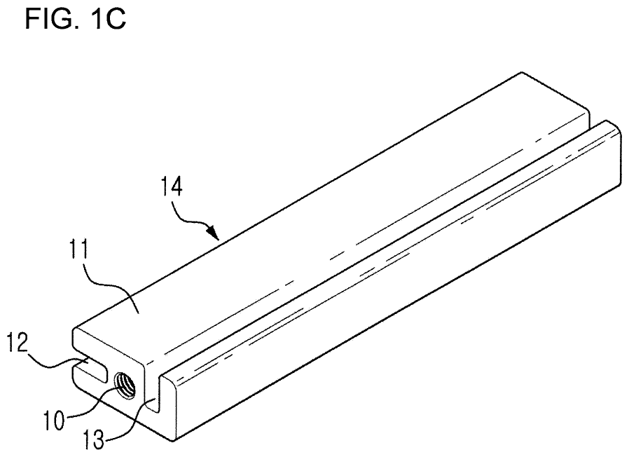

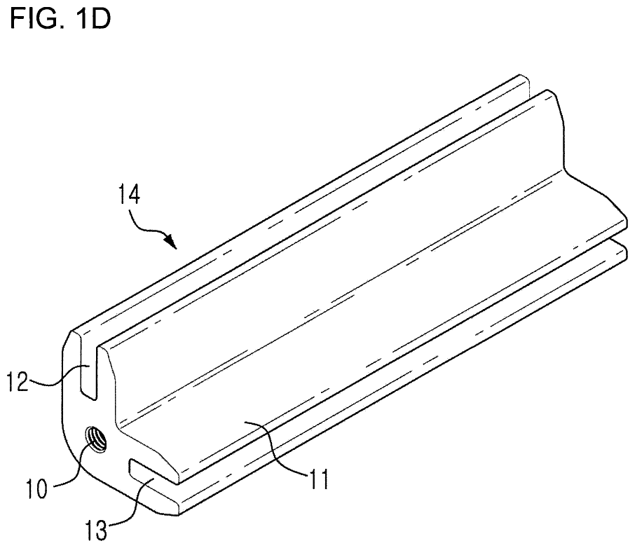

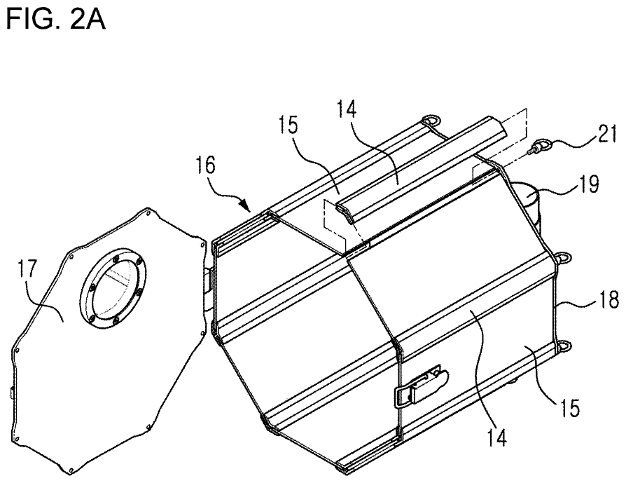

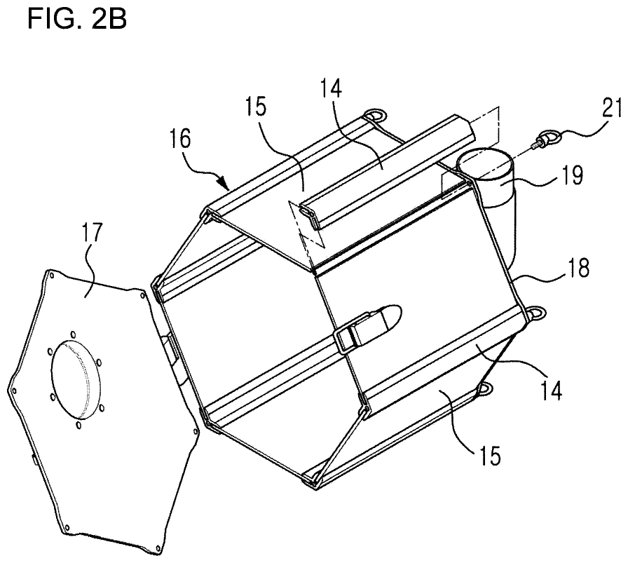

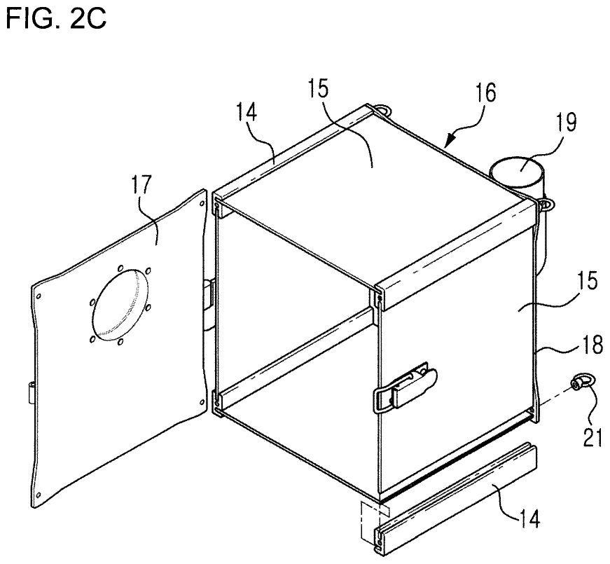

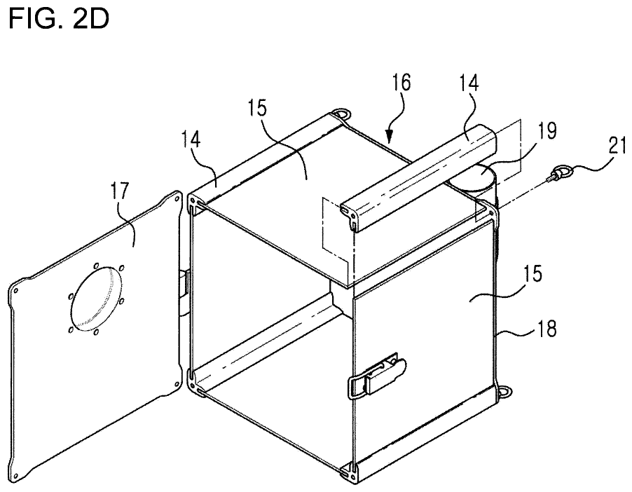

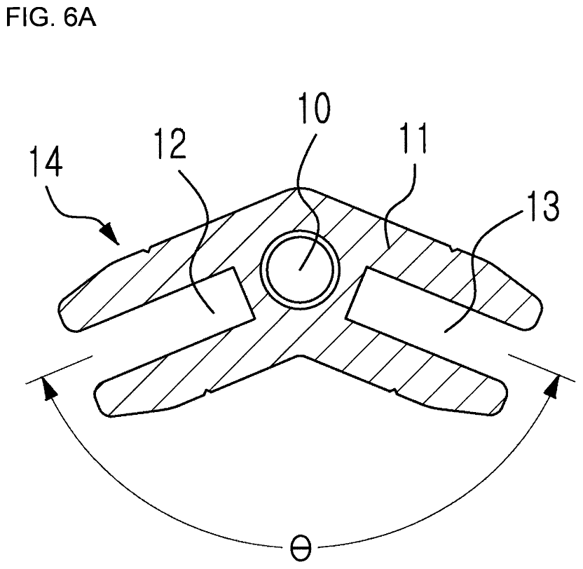

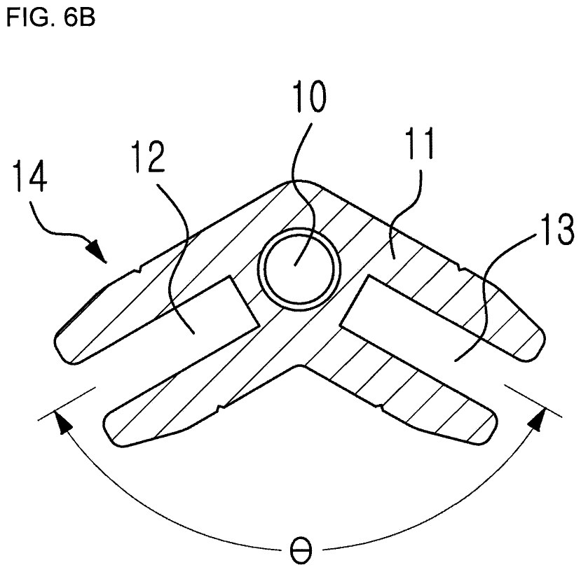

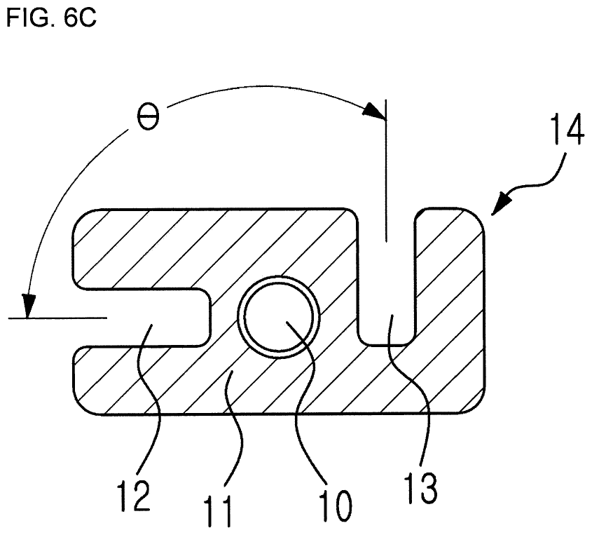

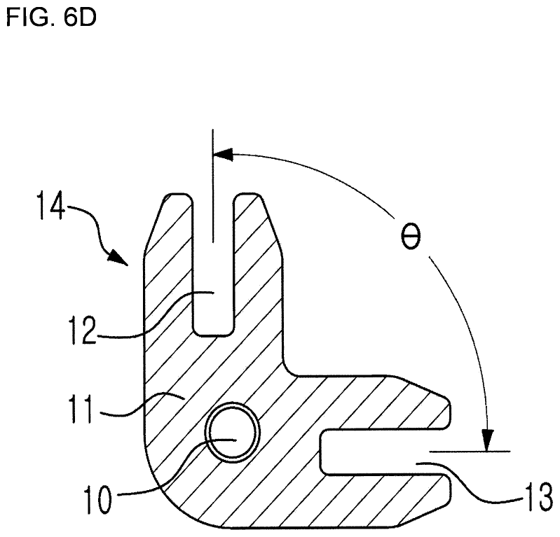

With reference to FIGS. 1A, 1B, 1C, and 1D; FIGS. 2A, 2B, 2C, and 2D; and FIGS. 6A, 6B, 6C, and 6D, a prefabricated module 14 for the brazier and roaster according to an exemplary embodiment of the present invention includes: a module body 11 provided with a fastening hole 10 (referring to a threaded hole) on an end side surface thereof; a first coupling groove 12 provided in a longitudinal direction at a side of the module body 11; and a second coupling groove 13 provided in the longitudinal direction at an opposite side of the module body 11 at an arbitrary angle with the first coupling groove 12.

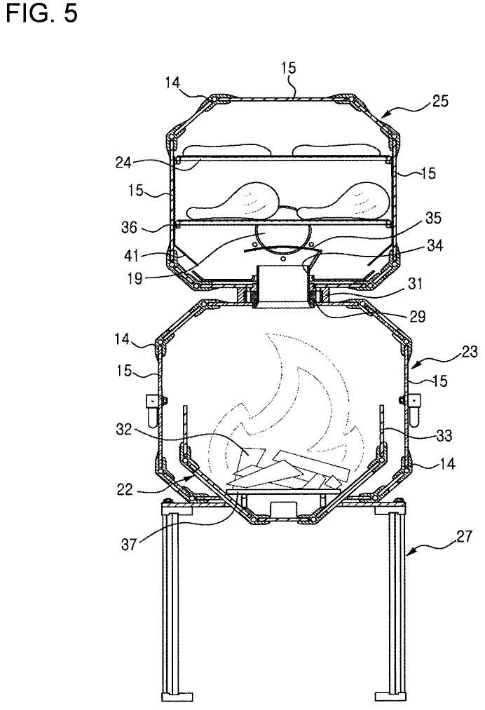

With reference to FIGS. 1A, 1B, 1C, and 1D to FIGS. 6A, 6B, 6C, and 6D, the prefabricated body using the module for the brazier and roaster according to an exemplary embodiment of the present invention includes: the module 14 including the module body 11 provided with the fastening hole 10 (referring to the threaded hole) on one an side surface thereof, the first coupling groove 12 provided in a longitudinal direction at a side of the module body 11, and the second coupling groove 13 provided in the longitudinal direction at the opposite side of the module body 11 at the arbitrary angle with the first coupling groove 12; a polygonal body 16 with both ends open configured by module plates 15 slidably and detachably coupled correspondingly with the first and second coupling grooves 12 and 13 in the longitudinal direction; a door 17 openably installed at one opening of one side of the polygonal body 16; and a side plate 18 installed at one opening of an opposite side of the polygonal body 16 so as to face the door 17 by a fastening member 26 coupled with the fastening hole 10.

The module 14 and the module plate 15 constitute the polygonal body 16, and the door 17 and the side plate 18 are made of an aluminum (Al) material having a high thermal conductivity and ceramic may be coated on inside and outside surfaces thereof.

As shown in FIGS. 1A, 2A, and 6A and FIGS. 3 to 5, the polygonal body 16 is configured in an octagonal shape when the angle θ that the first and second coupling grooves 12 and 13 of the module 14 make is 135 angle degrees.

As shown in FIGS. 1B, 2B, and 6B, the polygonal body 16 is configured in a hexagonal shape when the angle θ that the first and second coupling grooves 12 and 13 of the module 14 make is 120 angle degrees.

As shown in FIGS. 1C, 1D, 2C, 2D, 6C, and 6D, the polygonal body 16 is configured in a rectangular shape when the angle θ that the first and second coupling grooves 12 and 13 of the module 14 make is 90 angle degrees.

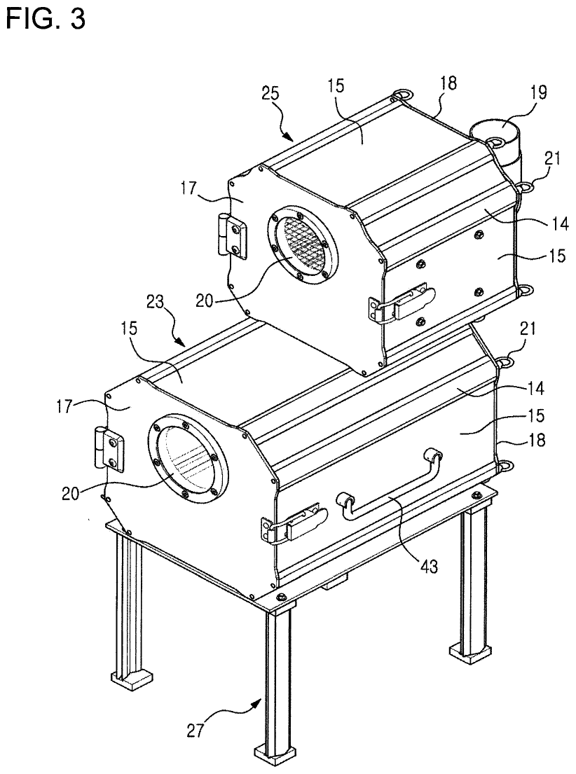

As shown in FIG. 3, the prefabricated body for the brazier and roaster is further provided with a vent pipe 19 formed on the side plate 18 of the polygonal body 16.

As a result, when the polygonal body 16 configured in one of a rectangular shape (shown in FIGS. 2C and 2D), a hexagonal shape (shown in FIG. 2B), and an octagonal shape (shown in FIG. 2A) is used as: a main body 23 for a roaster accommodating a charcoal tray provided with charcoal; and an upper body 25 for the roaster housing a grill 24, exhaust gas generated when the charcoal is burnt in the main body 23 may be discharged to the outside through the vent pipe 19 formed on the side plate 18 of the upper body 25.

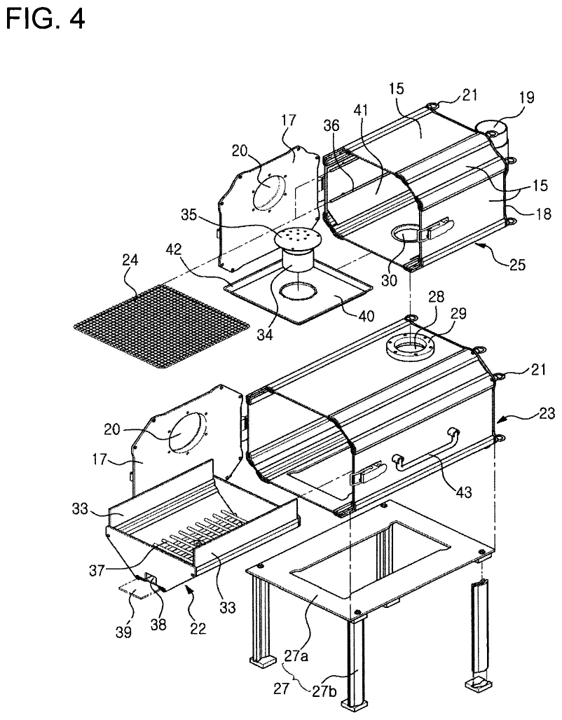

As shown in FIGS. 3 and 4, the main body 23 and the upper body 25 are characterized such that, according to an adjustment of the width size of the module plate 15 coupled with the first and second coupling grooves 12 and 13 of the module 14, sizes of sides, which configure in a polygonal shape of the main body 23 and the upper body 25, may be variable.

As shown in FIGS. 2A, 2B, 2C, 2D, 3, and 4, the door 17 is further provided with a sight glass 20 for visually confirming the inside of the polygonal body 16.

Accordingly, when the polygonal body 16 is used as the main body 23 for the roaster accommodating the charcoal tray 22 provided with the charcoal, a burning state and the like of the charcoal burnt in the charcoal tray 22 accommodated in the main body 23 may be visually confirmed from the outside through the sight glass 20 in a state of not opening the door 17.

In addition, when the polygonal body 16 is used as the upper body 25 for the roaster housing the grill 24, a cooking state of foods such as meat and the like being roasted on the grill 24 housed in the upper body 25 may be visually confirmed from the outside through the sight glass 20 in a state of not opening the door 17.

As shown in FIGS. 3 and 4, an eye bolt 21 or eye nut may be used as the fastening member 26 for detachably fixing the side plate 18 to the polygonal body 16 by being screwed into the fastening hole 10.

Accordingly, when the side plate 18 is installed to or separated from the polygonal body 16, installation and separation thereof may be accomplished even without using a separate tool (a driver and the like).

Reference numeral 43 in the drawings denotes a handle mounted on the outer surface of the main body 23.

Hereinafter, examples of use of the module and the prefabricated body using the same for the brazier and roaster according to an embodiment of the present invention will be described with reference to the accompanying drawings.

As shown in FIGS. 1A, 2A, and 6A and FIGS. 3 to 5, when the angle θ that the first and second coupling grooves 12 and 13 of the module 14 make is 135 angle degrees, the polygonal body 16 becomes an octagonal shape.

More specifically, the module plate 15 having thickness corresponding to width of the first coupling groove 12 and the second coupling groove 13 provided in the module 14 and having the length corresponding to the length of the module 14 is coupled with the first coupling groove 12 and the second coupling groove 13 of the module 14 and is slid in the longitudinal direction.

In other words, the door 17 is openably installed by a hinge at one opening of one side of a polygonal body 16 configured by the combination of modules 14 and module plates 15 coupled with first and second coupling grooves 12 and 13. In addition, a side plate 18 is fixed to one opening of the opposite side of the polygonal body 16.

In other words, the fastening member 26 is passed through a through hole (reference numeral is not shown) provided at an edge of the side plate 18 and screwed into the fastening hole 10 provided in the module 14, thereby fixing the side plate 18 to the polygonal body 16.

At this time, as the fastening member 26 is composed of a wing bolt, when the side plate 18 is fixed to the polygonal body 16 using the fastening member 26 screwed into the fastening hole 10 of the module 14, no separate tool such as a driver and the like is needed, thereby providing convenience to a user and shortening work time for assembling the polygonal body 16.

Meanwhile, when the polygonal body 16 is formed by coupling the module plates 15 with the first and second coupling grooves 12 and 13 of the neighboring modules 14, provided the width of each module plate 15 is the same, the polygonal body 16 has a regular octagonal shape.

As described above, as the module plate 15 is longitudinally slidably coupled with the first and second coupling grooves 12 and 13 of the module 14, the polygonal body 16 is configured in the octagonal shape with both ends open. In addition, the door 17 is openably installed at one opening of one side of the polygonal body 16, and the side plate 18 is fixed to one opening of an opposite side of the polygonal body 16 by the fastening member 26 made of a butterfly bolt in a one touch method. As a result, the octagonal body 16 may be easily assembled.

On the contrary, when an interior of the polygonal body 16 configured in the octagonal shape is contaminated, the polygonal body 16 may be easily separated into a state before being assembled, thereby being cleaned.

More specifically, when the fastening member 26, which fixes the side plate 18 to the fastening hole 10 of the module 14 so as to seal the opening of the opposite side of the polygonal body 16, is unfastened by a handle thereof being gripped, the side plate 18 may be easily separated from the polygonal body 16.

Further, the door 17, which is openably installed at one opening of the polygonal body 16, may be easily separated from the polygonal body 16 by hinge separation.

As described above, the module 14, the module plate 15 coupled with the first and second coupling grooves 12 and 13 of the module 14, the door 17 and the side plate 18 may be easily separated, wherein the module 14 and the module plate 15 constitute the polygonal body 16, and the door 17 and the side plate 18 are installed at both ends of the polygonal body 16, respectively.

Accordingly, the module 14, the module plate 15, the door 17, and the side plate 18 separated into a single unit may be hygienically cleaned.

Although not shown in the drawings, when the polygonal body 16 configured by the modules 14 having compatibility and the module plates 15 slidably coupled with the first and second coupling grooves 12 and 13 of the module 14; and the door 17 and the side plate 18 installed at openings of both ends of the polygonal body 16, respectively, are enlarged in size, an enlarged prefabricated roaster may be used for commercial use (referring to business use). Meanwhile, the module plate 15 is configured to have thickness corresponding to width of the first coupling groove 12 and the second coupling groove 13 provided in the module 14 and to have the length corresponding to the length of the module 14.

As shown in FIGS. 1B, 2B, and 6B, when the angle θ that first and second engaging grooves 12 and 13 configured in a module 14 make is 120 angle degrees, a polygonal body 16 configured by module plates 15 coupled with the first and second coupling grooves 12 and 13 becomes a hexagonal shape.

At this time, the polygonal body 16 having both ends open configured by coupling a module plate 15 with first and second coupling grooves 12 and 13 of the module 14, the door 17 openably installed by a hinge at an opening of one end of the body 16, and the side plate 18 detachably fixed by the fastening member 26 to one opening of an opposite end of the body 16 are configured substantially the same as constituent elements of the octagonal body 16 shown in FIG. 2A. Therefore, a detailed description of these constituent elements will be omitted, and the same reference numerals will be used for the same elements.

As shown in FIGS. 1C, 1D, 2C, 2D, 6C, and 6B, when an angle that first and second engaging grooves 12 and 13 configured in a module 14 make is 90 angle degrees, a polygonal body 16 configured by module plates 15 coupled with first and second coupling grooves 12 and 13 becomes a hexagonal shape.

At this time, a polygonal body 16 having both ends open configured by coupling module plates 15 with first and second coupling grooves 12 and 13 of a module 14, a door 17 openably installed by a hinge at an opening of one end of the body 16, and a side plate 18 detachably fixed by a fastening member 26 to one opening of an opposite end of the body 16 are configured substantially the same as constituent elements of the octagonal body 16 shown in FIG. 2A. Therefore, a detailed description of these constituent elements will be omitted, and the same reference numerals will be used for the same elements.

Hereinafter, examples of use of the module and the prefabricated body using the module for the brazier and roaster according to an embodiment of the present invention will be described with reference to the accompanying drawings.

As shown in FIGS. 3 to 5, the main body 23 in which the charcoal tray 22 is accommodated is seated on a leg rest portion 27, whereas the upper body 25 housing the grill 24 is swingably seated on the main body 23.

The leg rest portion 27 includes an upper plate 27a on which the main body 23 is seated and a leg 27b for supporting the upper plate 27a.

In other words, a first protrusion 29 protruding from an top surface of the main body 23 in a ring shape, which a thermal power discharge hole 28 is provided penetrating a center thereof, and a second protrusion 31 protruding from a bottom surface of the upper body 25 in a boss shape, which a thermal power inflow hole 30 is provided penetrating a center thereof, are jaggedly and rotatably coupled correspondingly with each other.

Accordingly, the upper body 25 may be swung clockwise or counterclockwise with respect to the main body 23.

That is, in a state where the main body 23 seated on the leg portion is fixed, the position of the door 17, which is openably installed to the upper body 25, may be changed due to the swing of the upper body 25,

Thus, a user may eat food such as meat and the like, which are roasted put on the grill 24 housed in the upper body 25 without moving around the roaster.

As described above, when the coal 32 seated in the charcoal tray 22 accommodated in the main body 23 is ignited and burnt, the thermal power of the charcoal 32 is discharged through the thermal power discharge hole 28 of the main body 23.

At this time, the thermal power of the charcoal 32 may be directed toward the upper body 25 by the flame guide plates 33 provided facing each other at the left and right upper ends of the charcoal tray 22. That is, the thermal power of the charcoal 32 may be prevented from being stagnated in the inner space of the main body 23, thereby improving the thermal efficiency.

The thermal power discharged from the main body 23 is moved into the upper body 25 through the thermal power inflow hole 30 of the upper body 25 communicated with the thermal power discharge hole 28.

In other words, the thermal power in the main body 23 is moved into the upper body 25 by a connector 34 provided to communicate the thermal power discharge hole 28 and the thermal power inflow hole 30 with each other and then is diffused in the radial direction by the thermal power spreading tool 35 in the form of a block plate configured to be spaced apart from the upper end of the connector 34.

As described above, the food such as meat and the like placed on the grill 24 seated on guide rails 36 provided facing each other on the inner surface of the upper body 25 is uniformly heated and roasted by the thermal power diffused by the thermal power spreader 35. That is, the thermal power may be prevented from being locally focused to heat the food on the grill 24.

Although it is not shown in the drawings, it is naturally possible to assemble the roaster so that the food such as meat and the like put on the grill 24 accommodated in the upper body 25 is roasted by heating of an electrothermal heater (not shown) housed in the main body 23.

In this case, the technique of cooking the food on the grill 24 by heating by turning on the electrothermal heater by the power supply is one used in the technical field to which the present invention belongs, therefore, detailed description of the constitution will be omitted.

Meanwhile, when burnt ash is accumulated in the charcoal holder 37 of the charcoal tray 22, the ash burnt in the charcoal tray 22 may be easily discharged from the roaster by allowing the discharge plate 39 coupled with the charcoal tray 22 to be slidably moved to open and close the slit portion 38 provided on the bottom surface of the charcoal tray 22.

In addition, when the meat and the like on the grill 24 are heated to roast, a foreign substance such as oil or a meat residue dripping from the meat drops into an oil pan 40 provided below the grill 24.

That is, the foreign substance dripping from the meat drops into the oil pan 40 through a chute 41 provided between the oil pan 40 and an inner surface of the upper body 25.

Accordingly, oil constituents may allow the inner surface of the upper body 25 to be minimized from being contaminated due to foreign substances.

In addition, the oil dropped into the oil pan 40 may be prevented from overflowing into the upper body 25 by a separation prevention threshold 42 provided protrudingly from ends of a top surface of the oil pan 40.

Here, although the present invention has been described with reference to the preferred embodiments thereof, those skilled in the art will appreciate that various modifications and changes may be made thereto without departing from the spirit and scope of the present invention as defined in the following claims.

What is claimed is:

1. A prefabricated body using a module for a brazier and roaster, the prefabricated body comprising:
a module including a module body provided with a fastening hole on an end side surface thereof, a first coupling groove provided in a longitudinal direction at a side of the module body, and a second coupling groove provided in the longitudinal direction at an opposite side of the module body at an arbitrary angle with the first coupling groove;
a polygonal body with both ends open and configured by module plates detachably coupled correspondingly with the first and second coupling grooves;
a door openably installed at an opening at a side of the polygonal body; and
a side plate installed at an opening at an opposite side of the polygonal body so as to face the door by a fastening member coupled with the fastening hole, wherein
the polygonal body is configured in one of a rectangular shape, a hexagonal shape, and an octagonal shape, and sizes of sides thereof is variable according to an adjustment of width sizes of the module plates coupled with the first and second coupling grooves of the module, and is used as a main body for a roaster accommodating a charcoal tray provided with charcoal and an upper body for a roaster housing a grill; and
the fastening member coupled with the fastening hole is an eye bolt.

2. The prefabricated body of claim 1, wherein, when an angle that the first and second coupling grooves of the module make is 135 angle degrees, the polygonal body becomes to be configured in an octagonal shape.

3. The prefabricated body of claim 1, wherein, when an angle that the first and second coupling grooves of the module make is 120 angle degrees, the polygonal body becomes to be configured in a hexagonal shape.

4. The prefabricated body of claim 1, wherein, when an angle that the first and second coupling grooves of the module make is 90 angle degrees, the polygonal body becomes to be configured in a rectangular shape.
